(19) United States
(12) Patent Application Publication
(10) Pub. No.: US 2012/0296989 A1
(43) Pub. Date: Nov. 22, 2012

(54) FILE TRANSMISSION MANAGEMENT SYSTEM AND FILE TRANSMISSION MANAGEMENT METHOD FOR SUPPORTING FILE TRANSMISSION IN MOBILE MESSAGING SERVICE

(75) Inventors: Suk Young Lee, Seongnam-si (KR); Soo Young Kim, Seongnam-si (KR); Gyu Il KIM, Seongnam-si (KR); Jin Soo Park, Seongnam-si (KR); Austin Kim, Seongnam-si (KR); Hae Seong Choi, Seongnam-si (KR)

(73) Assignee: NHN Corporation, Seongnam-si (KR)

(21) Appl. No.: 13/296,541

(22) Filed: Nov. 15, 2011

(30) Foreign Application Priority Data
Nov. 15, 2010 (KR) 10-2010-0113343

(51) Int. Cl. G06F 15/16

(52) U.S. Cl. 709/206

(57) ABSTRACT

Exemplary embodiments of the present invention disclose a file transmission management system and a file transmission management method for supporting a file transmission in a mobile messaging service. The file transmission management system may include a file transmission manager to receive a file from an Internet storage space associated with a user when the user requests a transmission of the file stored in the Internet storage space.

### CROSS REFERENCE TO RELATED APPLICATION

This application claims priority from and the benefit of Korean Patent Application No. 10-2010-0113343, filed on Nov. 15, 2010, which is hereby incorporated by reference for all purposes as if fully set forth herein.

### BACKGROUND OF THE INVENTION

1. Field of the Invention

Exemplary embodiments of the present invention relate to a file transmission management system and a file transmission management method for supporting a file transmission in a mobile messaging service.

2. Discussion of the Background

A messenger may be a software application that enables users to transmit and receive messages and data in real time over a wired and/or wireless network. A mobile messaging service using the messenger may support multipoint chatting and voice chatting, and may also support a transmission of a file, such as an image or a moving picture.

However, a mobile messaging service conventionally supports only a transmission of a file stored in a storage space of a terminal in which a messenger is installed.

For example, when the messenger is installed in a personal computer (PC), a user may transmit, to another user, only a file stored in a hard disk of the PC. To transmit a file that is not stored in the hard disk of PC, the user may need to download and store the corresponding file in the hard disk of PC and then transmit the file to the other user using the messenger application. For mobile terminals, only a file stored in the mobile terminal may be transmitted, which may hinder the ability of a user to send desired files. Accordingly, in conventional file transmissions of the mobile terminal using the mobile messaging service, the messaging service may be limited due to constraints in resources of the mobile terminal.

Accordingly, a system and method that may more effectively transmit a file using a mobile messaging service is needed.

### SUMMARY OF THE INVENTION

Exemplary embodiments of the present invention provide a file transmission management system and method including receiving a file selected by a user from among files stored in a mobile messaging terminal of the user or files stored in an Internet storage space excluding the mobile messaging terminal and providing the received file to another user, when transmitting a file using a mobile messaging service.

Exemplary embodiments of the present invention also provide a file transmission management system and method including transmitting a corresponding file to a mobile messaging terminal of a user to which the file is to be provided using a mobile messaging service, and/or storing the corresponding file in an Internet storage space of the user.

Additional features of the invention will be set forth in the description which follows, and in part will be apparent from the description, or may be learned by practice of the invention.

Exemplary embodiments of the present invention disclose a file transmission management system that includes a controller to receive a file from an Internet storage unit associated with a first terminal in response to receiving a request for transmission of the file from the first terminal using a messaging service.

Exemplary embodiments of the present invention also disclose a file transmission management system that includes a controller to receive a file and store the file in an Internet storage unit associated with a second terminal in response to receiving a request from a first terminal for transmission of the file through a messaging service.

Exemplary embodiments of the present invention also disclose a file transmission management method. The method includes receiving a file from an Internet storage unit associated with a first terminal in response to receiving a request for transmission of the file from the first terminal using a messaging service. The file is stored in the Internet storage unit associated with the first terminal

Exemplary embodiments of the present invention also disclose a file transmission management method that includes storing a file in an Internet storage unit associated with a second terminal in response to a request from a first terminal for transmission of the file through a messaging service.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating an overall environment of a file transmission management system according to exemplary embodiments of the present invention.

FIG. 2 is a diagram illustrating a process of uploading a file stored in a user terminal using a mobile messaging service according to exemplary embodiments of the present invention.

FIG. 3 is a diagram illustrating a process of uploading a file stored in an Internet storage system through a mobile messaging service according to exemplary embodiments of the present invention.

FIG. 4 is a diagram illustrating a process of storing a received file in a user terminal through a mobile messaging service according to exemplary embodiments of the present invention.

FIG. 5 is a diagram illustrating a process of storing a received file in an Internet storage system associated with a user through a mobile messaging service according to exemplary embodiments of the present invention.

FIG. 6 is a diagram illustrating a process of storing conversations and/or messages through a mobile messaging service according to exemplary embodiments of the present invention.

FIG. 7 is an example of a screen used to select a file stored in a terminal according to exemplary embodiments of the present invention.

FIG. 8 is an example of a screen used to select a file stored in an Internet storage system according to exemplary embodiments of the present invention.

FIG. 9 is an example of a screen used to transmit a file, and a screen to accept a file transmission according to exemplary embodiments of the present invention.

FIG. 10 is a block diagram illustrating a configuration of a file transmission management system according to exemplary embodiments of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element is referred to as being “connected to” another element, it can be directly connected to the other element, or intervening elements may be present.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It may also be understood that for the purposes of this disclosure, “at least one of X, Y, and Z” can be construed as X only, Y only, Z only, or any combination of two or more items X, Y, and Z (e.g., XYZ, XYY, YZ, ZZ).

Hereinafter, exemplary embodiments of the present invention are described in detail with reference to the accompanying drawings.

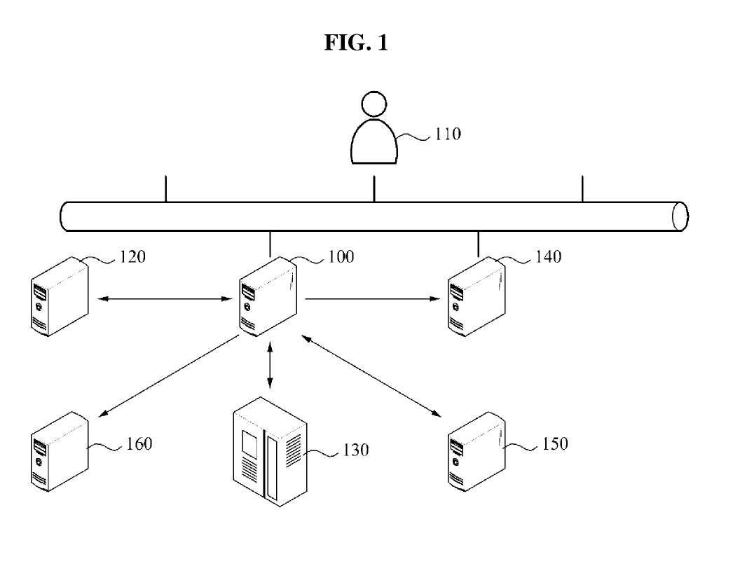

FIG. 1 is a diagram illustrating an overall environment of a file transmission management system 100. FIG. 1 shows the file transmission management system 100, a client 110, an Internet storage system 120 (e.g., storage system accessible via the Internet), a temporary storage system 130, a session control server 140, a database gateway (DBGW) 150, and a mail server 160.

When a file transmission between users is requested through a mobile messaging service, the file transmission management system 100 may receive a file from the Internet storage system 120 associated with the users, or may store a received file in the Internet storage system 120. The Internet storage system 120 may include a system of uploading or downloading files of users in a file storage space on the Internet.

The Internet storage system 120 may include a single system or may include a plurality of systems. In some cases, a single system providing an Internet storage space assigned to respective users may be employed as the Internet storage system 120. Different systems providing an Internet storage space with respect to at least two users may be employed as the Internet storage system 120. The Internet storage system 120 associated with a first user and an Internet storage system 120 associated with the second user may be the same system, or may be different from each other.

The file transmission management system 100 may include a file transmission manager (not shown), and may execute a process of receiving or storing a file through the file transmission manager. The file transmission management system 100 may also temporarily store a file in the temporary storage system 130, or may receive a temporarily stored file in the temporary storage system 130, to transmit to user terminals or the Internet storage system 120.

For example, when a first user requests to perform file transmission to a second user through the mobile messaging service, the file transmission management system 100 may receive a file selected by the first user from among a plurality of files of the first user stored in the Internet storage system 120 associated with the first user, and may provide the received file to the second user. In this example, the file transmission management system 100 may transmit the corresponding file to a terminal of the second user or the Internet storage system 120 associated with the second user.

As another example, when a first user requests to perform file transmission to a second user through the mobile messaging service, the file transmission management system 100 may transmit a received file to the Internet storage system 120 associated with the second user.

In this example, the file transmission management system 100 may receive the corresponding file from the terminal of the first user or the Internet storage system 120 associated with the first user.

In some cases, the file of the first user received by the file transmission management system 100 may be stored in the temporary storage system 130. For example, a file transmission of the first user with respect to the second user may be performed only when the second user approves the file transmission. The file transmission management system 100 may temporarily store the file in the temporary storage system 130 until the second user approves the file transmission. When the second user approves the file transmission, the file transmission management system 100 may receive the file stored in the temporary storage system 130 and may provide the received file to the second user.

The client 110 may be a wired and/or wireless terminal used when the users use the mobile messaging service. At least one of the first user who desires to transmit a file and the second user who desires to receive the file (or vice-versa) may use a terminal. For example, when a user desires to transmit a file to another user through a wired and/or wireless terminal, the file transmission management system 100 may execute at least one of a process of uploading a file from a user and a process of downloading the file to another user through the Internet storage system 120 and thereby, more efficiently managing a file transmission regardless of constraints in resources of a terminal. Examples of a terminal include, but are not limited to, a mobile phone, a smartphone, a navigation device, a computer, a laptop, and, in general, any suitable portable electronic device having the capacity to connect to the Internet.

In interworking with the Internet storage system 120, in some cases, the file transmission management system 100 may transmit a file selected by a user from among files of the user stored in the Internet storage system 120, to a terminal of another user or the Internet storage system 120 associated with the other user. In some cases, the file transmission management system 100 may receive a file stored in the user terminal or the Internet storage system 120 associated with the user. The file transmission management system 100 may then store the received file in the Internet storage system 120 associated with the other user or may transmit the received file to the terminal of the other user. Therefore, when a file that is not stored in the terminal of the user but is stored in the Internet storage system 120 associated with the user, the user may transmit the corresponding file to another user without downloading the corresponding file to the user's terminal. Users receiving a file may optionally store the file in the Internet storage system 120 without downloading the file to the receiving user's terminal. Data transmission and reception between the file transmission management system 100 and the Internet storage system 120 may be performed using, for example, a Transmission Control Protocol (TCP)/HyperText Transfer Protocol (HTTP).

The temporary storage system 130 may temporarily store an uploaded file. For example, when a file desired to be transmitted is uploaded, the file transmission management system 100 may store the uploaded file in the temporary storage system 130 until another user approves a transmission of the file. In the mobile messaging service, a file may be transmitted after a correspondent user to receive the file approves a file transmission. Thus, the file transmission management system 100 may need to maintain the corresponding file during at least a period from a point in time when the file is uploaded to a point in time when the file transmission is approved. For this, the file transmission management system 100 may temporarily store the uploaded file in the temporary storage system 130. Data transmission and reception between the file transmission management system 100 and the temporary storage system 130 may be performed using, for example, a TCP. The temporary storage system 130 may include, for example, a distributed server. The file transmission management system 100 may transmit and receive data to and from a management server of the temporary storage system 130.

The session control server 140 may manage a connection session through terminals of users with respect to a file transmission. The session control server 140 may manage a connection session between the file transmission management system 100 and the client 110. The client 110 may be any user terminal involved in file transmission using the file transmission management system 100. The session control server 140 may be included in the file transmission management system 100 as a session manager (not shown) or may be a separate system. The session control server 140 may transmit transmission state information and transmission result information associated with a file transmission to user terminals. For example, the session control server 140 may transmit, to the client 110, information indicating that a file is being uploaded or information indicating that a file transmission has been completed. Data transmission and reception between the file transmission management system 100 and the session control server 140 may be performed by, for example, a transmission system that guarantees connection between servers and transmits one or more message packets.

The DBGW 150 may perform database session management and may convert a requested command to an assigned query to return a result corresponding to the assigned query. For example, the DBGW 150 may enquire about the client 100 through a client enquiry command and provide an enquiry result to the file transmission management system 100. In some cases, a Network Parameter Control (NPC) protocol may be employed when the file transmission management system 100 requests the DBGW 150 for a command requesting a database query.

The mail server 160 may store messages, data packets, and/or conversation between users. When the client 100 requests storage of conversations, the file transmission management system 100 may store corresponding conversations in the mail server 160 in association with the client 110. The file transmission management system 100 may also store the conversations in the Internet storage system 120 to back up the conversations.

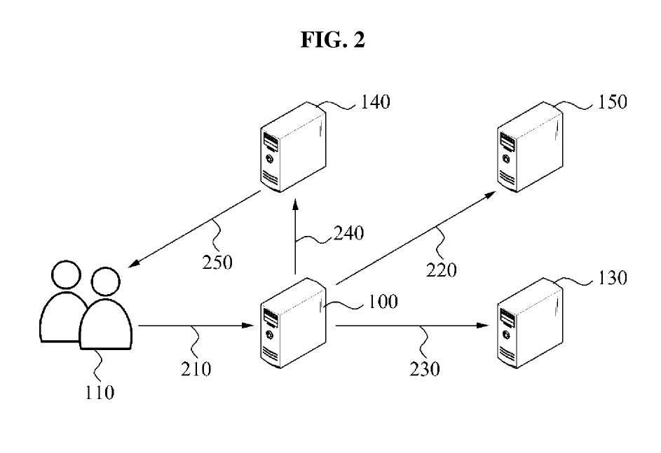

FIG. 2 is a diagram illustrating a process of uploading a file stored in a user terminal using a mobile messaging service according to an exemplary embodiment of the present invention. FIG. 2 illustrates the file transmission management system 100, the client 110, the temporary storage system 130, the session control server 140, and the DBGW 150, which are described above with reference to FIG. 1.

When the client 110 transmits a file for uploading to the file transmission management system 100 together with a file transmission request (210), the file transmission management system 100 may first verify and then add, if needed, the client 110 using the DBGW 150 (220). The file transmission management system 100 may store the uploaded file in the temporary storage system 130 (230), and may transmit transmission state information or transmission result information to the session control server 140 (240). For example, the session control server 140 may transfer the transmission state information or the transmission result information to the client 110 (250).

For example, the client 110 may directly transmit, to the file transmission management system 100, the file that is stored in the client 110. The file transmission management system 100 may store the uploaded file in the temporary storage system 130 for a predetermined period of time. In some cases, the file transmission management system 100 may store the uploaded file in the temporary storage system 130 until a user who is to receive the file approves the file transmission and thereby, the file is transmitted to the user.

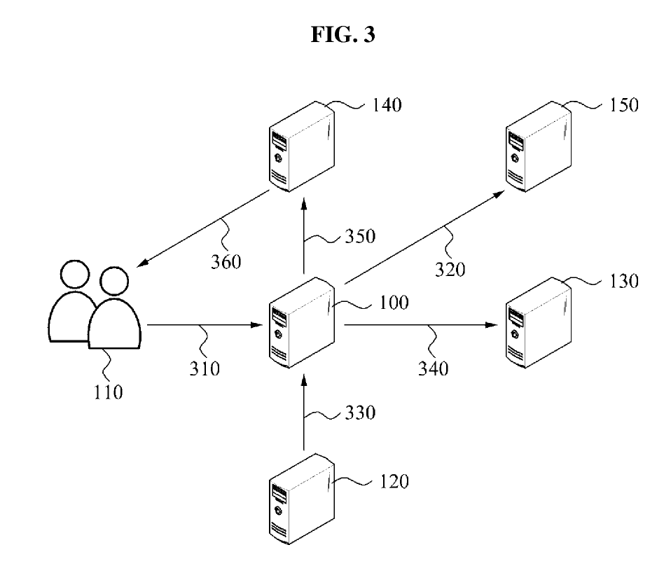

FIG. 3 is a diagram illustrating a process of uploading a file stored in an Internet storage system 120 through a mobile messaging service according to exemplary embodiments of the present invention. FIG. 3 illustrates the file transmission management system 100, the client 110, the Internet storage system 120, the temporary storage system 130, the session control server 140, and the DBGW 150, which are described above with reference to FIG. 1.

When the client 110 requests the file transmission management system 100 for a file transmission (310), the file transmission management system 100 may first verify and then add, if needed, the client 110 using the DBGW 150 (320). The file transmission management system 100 may receive a file selected by the client 110 from the Internet storage system 120 (330), and may store the received file in the temporary storage system 130 (340). The file transmission management system 100 may transmit transmission state information or transmission result information to the session control server 140 (350). The session control server 140 may transfer the transmission state information or the transmission result information to the client 110 (360).

For example, the client 110 may select at least one file from among a plurality of files of the client 110 that are stored in the Internet storage system 120, using a message or file selection interface displayed on a display screen of the client 110. The file transmission management system 100 may receive the file selected by the client 110, from the Internet storage system 120 and may store the received file in the temporary storage system 130.

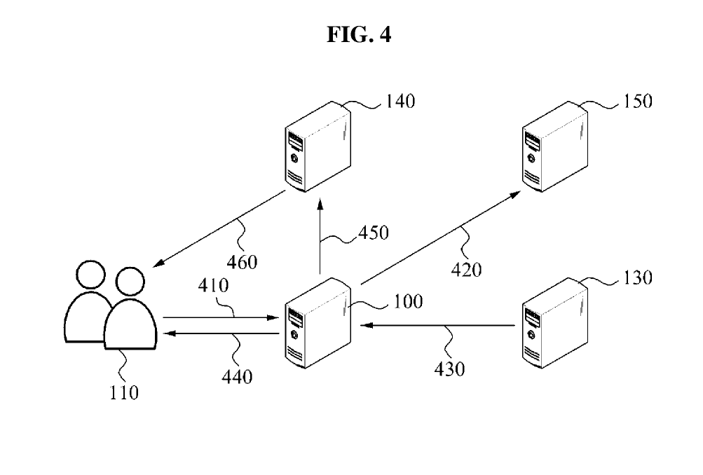

FIG. 4 is a diagram illustrating a process of storing a received file in a user terminal through a mobile messaging service according to an exemplary embodiment of the present invention. FIG. 4 illustrates the file transmission management system 100, the client 110, the temporary storage system 130, the session control server 140, and the DBGW 150, which are described above with reference to FIG. 1.

When a client 110 approves a file transmission, a file transmission request signal may be transferred from the client 110 to the file transmission management system 100 (410). The file transmission management system 100 may first verify and then select the client 110 using the DBGW 150 (420). The file transmission management system 100 may receive a file that is stored in the temporary storage system 130 (430), and may transmit the received file to the client 110 (440). For example, the file stored in the temporary storage system 130, as explained with reference to FIG. 2 or FIG. 3, may be transmitted to the client 110. The client 110 described with reference to FIG. 2 or FIG. 3 may be a user terminal that desires to transmit a file, the client 110 of FIG. 4 may be a user terminal that is a target of the file transmission. Thus, a file may be transmitted from different user terminals through the mobile messaging service. If the same user is logged in a plurality of terminals, or if a single user is enabled to login using a plurality of identifiers (IDs), a file may be transmitted from the plurality of terminals of the same user through the mobile messaging service.

The file transmission management system 100 may transmit transmission state information or transmission result information to the session control server 140 (450). The session control server 140 may transfer the transmission state information or the transmission result information to the client 110 (460).

As described above, the client 110 may approve a file transmission and thereby receive a file to be transferred to another client 110 through the file transmission management system 100.

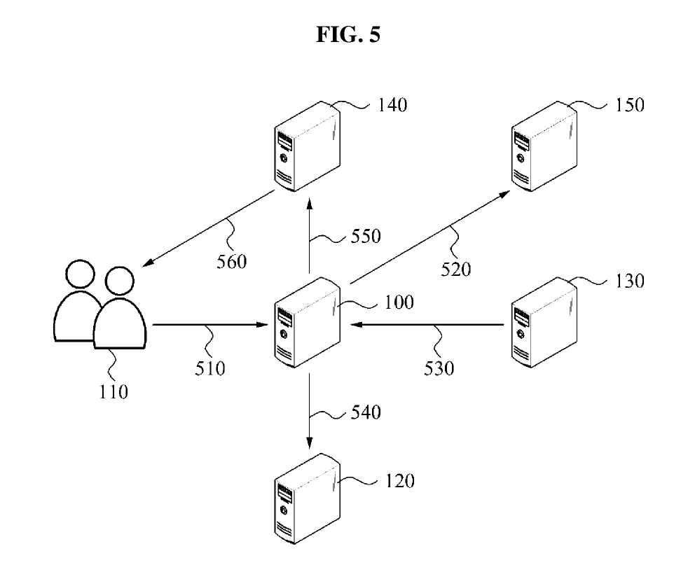

FIG. 5 is a diagram illustrating a process of storing a received file in an Internet storage system 120 associated with a user through a mobile messaging service. FIG. 5 illustrates the file transmission management system 100, the client 110, the Internet storage system 120, the temporary storage system 130, the session control server 140, and the DBGW 150, which are described above with reference to FIG. 1.

When the client 110 approves a file transmission, a file transmission request signal may be transferred from the client 110 to the file transmission management system 100 (510). The file transmission management system 100 may first verify and then select the client 110 using the DBGW 150 (520). The file transmission management system 100 may receive a file that is stored in the temporary storage system 130 (530), and may store the received file in the Internet storage system 120 associated with the client 110 (540). For example, the corresponding file may be stored in a storage space assigned to the client 110 in the Internet storage system 120.

The file transmission management system 100 may transmit transmission state information or transmission result information to the session control server 140 (550). The session control server 140 may transfer the transmission state information or the transmission result information to the client 110 (560).

As described above, the client 110 may approve a file transmission and thereby enable a file to be transferred to the client 110 to be stored in the Internet storage system 120. In addition, the client 110 may verify the corresponding file via the Internet storage system 120, or may receive the corresponding file from the Internet storage system 120 and subsequently store and/or verify the file.

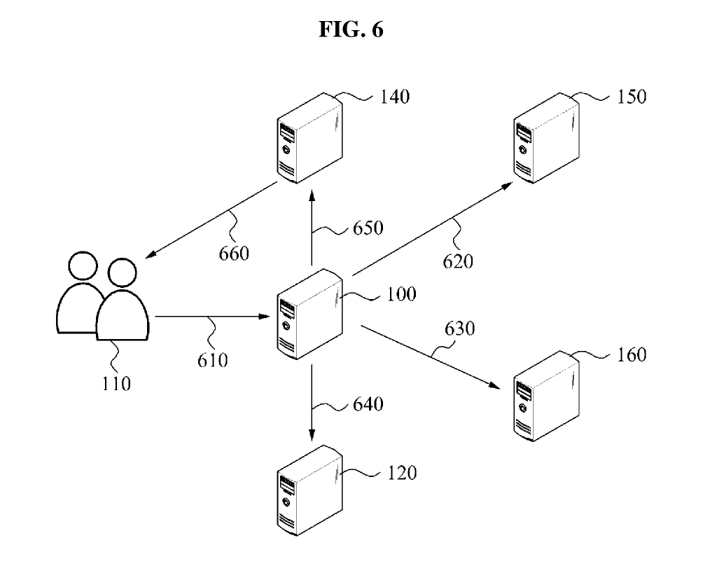

FIG. 6 is a diagram illustrating a process of storing conversations and/or messages through a mobile messaging service according to exemplary embodiments of the present invention. FIG. 6 illustrates the file transmission management system 100, the client 110, the Internet storage system 120, the session control server 140, the DBGW 150, and the mail server 160, which are described above with reference to FIG. 1.

When the client 110 requests a backup for conversations and/or messages between users (610), the file transmission management system 100 may first verify and then select the client 110 using the DBGW 150 (620). The file transmission management system 100 may back up the conversations and/or messages in the mail server 160 (630), or may back up the dialogues in the Internet storage system 120 (640). Thus, separate from a configuration of storing conversations and/or messages in a user terminal, the conversations and/or messages may be backed up in the Internet storage system 120 (630) and/or the mail server 160 (640). Accordingly, it is possible to prevent the conversations and/or messages from being deleted due to, for example, a malfunction or loss of the terminal.

The file transmission management system 100 may also transmit transmission state information or transmission result information to the session control server 140 (650). The session control server 140 may transfer the transmission state information or the transmission result information to the client 110 (660).

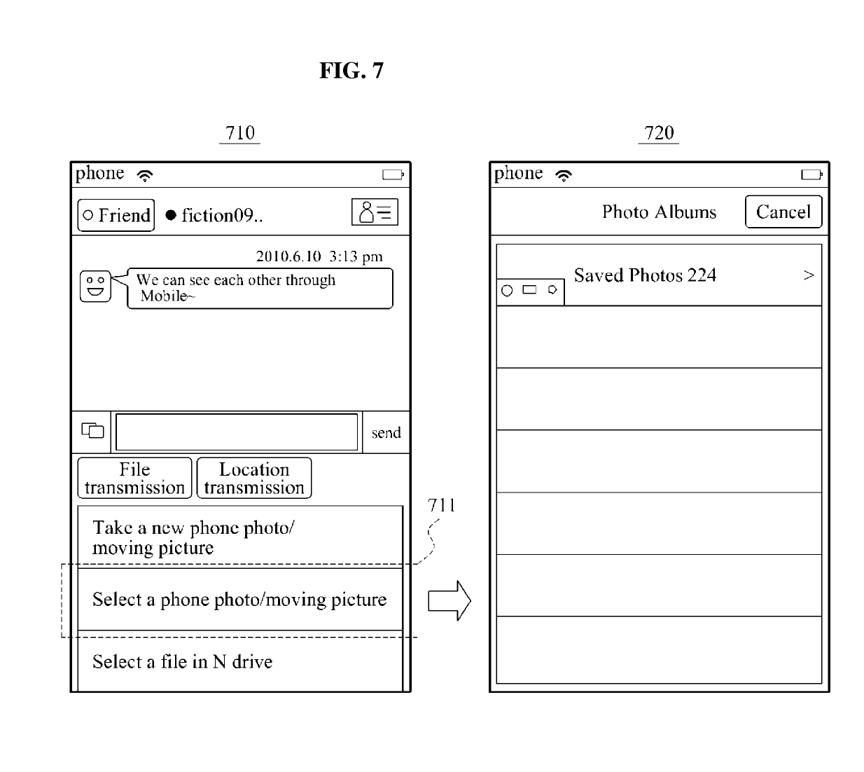

FIG. 7 illustrates an example of a screen used to select a file stored in a terminal according to exemplary embodiments of the present invention. A first screen 710 displays a file transmission interface of a messenger installed on a terminal or client 110. When a first user selects a function “select a phone photo/moving picture”, as indicated by dotted box 711, a file selection interface for selecting a file stored in the terminal may be displayed, as shown in a second screen 720. When the first user selects a file (i.e., photo or moving picture file) to transmit via the file selection interface using, for example, a conventional file selection method known in the art, the selected file may be stored in the temporary storage system 130 through the process of FIG. 2, and/or may be transmitted to either a second user having a conversation with the first user or a second user selected by the first user. As described above with reference to FIG. 4 and FIG. 5, the file may be directly downloaded to a terminal of the second user, or may be stored in a storage space of the Internet storage system 120 configured to store files of the second user.

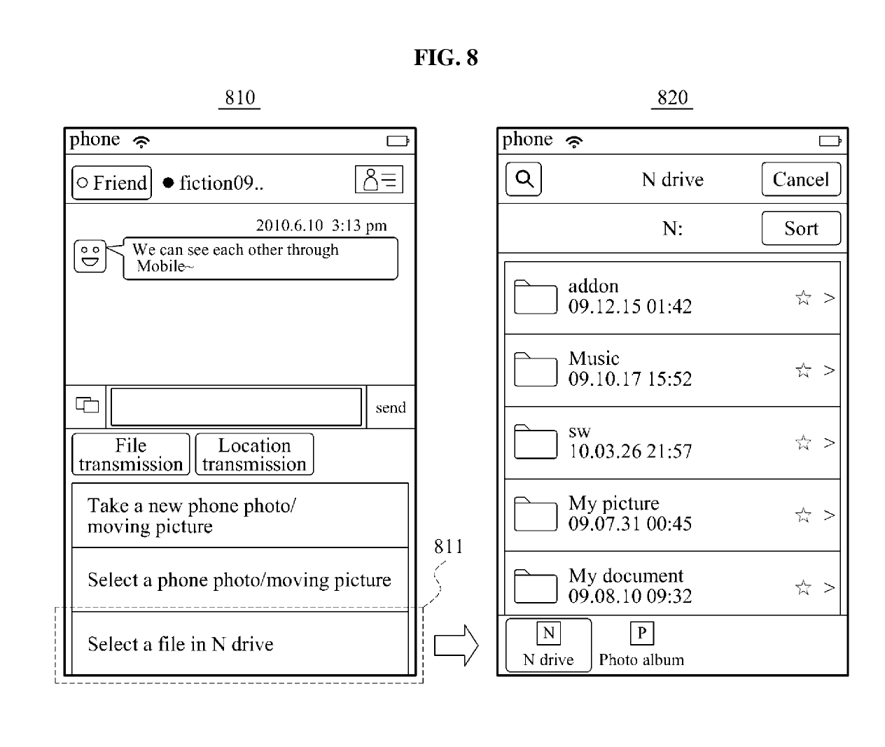

FIG. 8 illustrates an example of a screen used to select a file stored in an Internet storage system 120 according to exemplary embodiments of the present invention. A first screen 810 displays a file transmission interface of a messenger installed in a terminal or client 110.

When a first user selects a function “select a file in N drive”, as indicated by dotted box 811, a file selection interface for selecting a file stored in “N drive” may be displayed, as shown in a second screen 820. The “N drive” may refer to an example of a name of a service provided from the Internet storage system 120 or a directory of files stored in the Internet storage system 120. For example, the first user may select a file to be transmitted from among one or more files of the first user that are stored in the Internet storage system 120, via the file selection interface provided from the messenger. When the first user selects a file to be transmitted via the file selection interface using, for example, a conventional file selection method known in the art, the selected file may be stored in the temporary storage system 130 through the process of FIG. 3, and/or may be transmitted to either a second user having a conversation with the first user or a second user selected by the first user. As described above with reference to FIG. 4 and FIG. 5, the file may be directly downloaded to a terminal of the second user, or may be stored in a storage space of the Internet storage system 120 configured to store files of the second user.

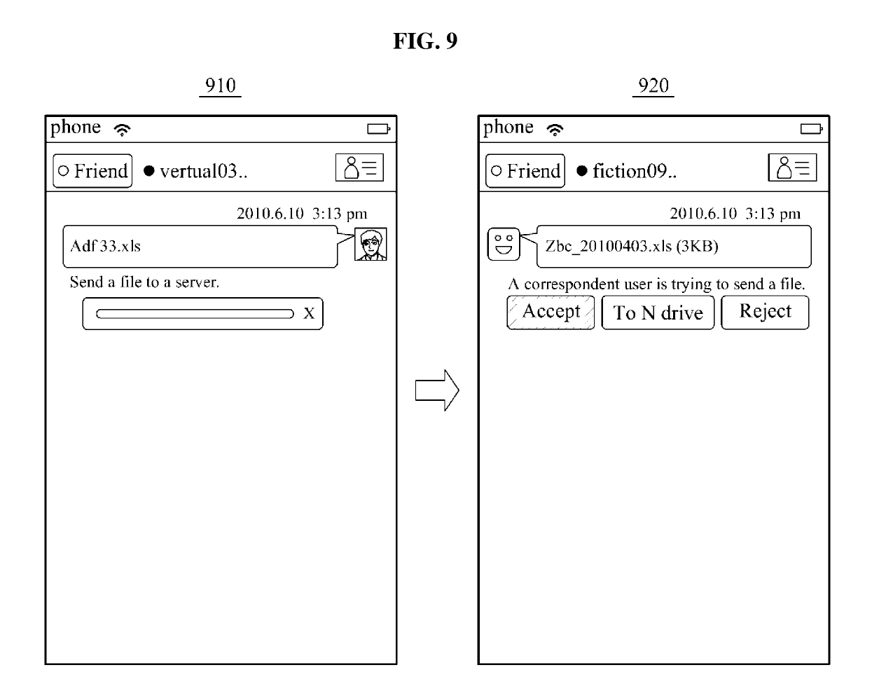

FIG. 9 illustrates an example of a screen used to transmit a file, and a screen to accept a file transmission according to exemplary embodiments of the present invention. A first screen 910 is an example of a screen displayed by the first user's terminal when the first user that desires to transmit a file to a second user. A second screen 920 is an example of a screen is displayed on a terminal of the second user when a file transmission request is received. The second user may accept or reject the file transmission request. When the file transmission request is accepted, a corresponding file may be stored in the second user's terminal. The second user may also enable the corresponding file to be stored in a storage space of the Internet storage system 120 using a function “to N drive” displayed on the second screen 920.

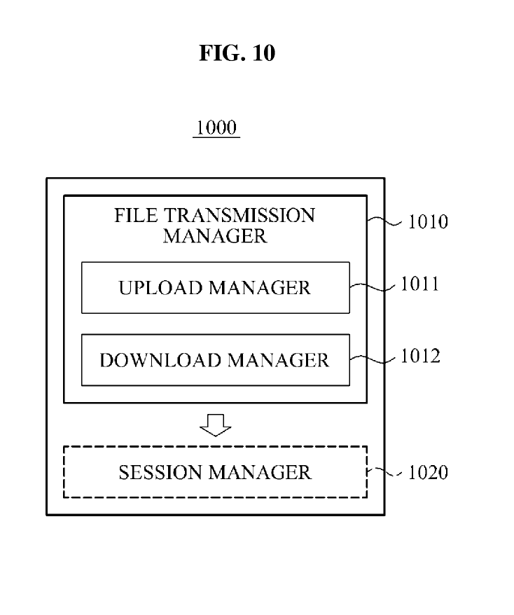

FIG. 10 is a block diagram illustrating a configuration of a file transmission management system 1000 according to exemplary embodiments of the present invention. Referring to FIG. 10, the file transmission management system 1000 may include a file transmission manager 1010 and, in some cases, a session manager 1020.

When a first user requests a transmission of a file stored in a Internet storage space 120 of the first user through a mobile messaging service, the file transmission manager 1010 may receive the file from the Internet storage space 120 associated with the first user, or may store the received file in a Internet storage space 120 associated with a second user according to a preference of the second user.

For example, when the first user requests the second user for file transmission through the mobile messaging service, the file transmission manager 1010 may include an upload manager 1011 to receive a file selected by the first user from among a plurality of files of the first user stored in the Internet storage space 120 associated with the first user, and a download manager 1012 to provide a file to the second user corresponding to the first user's request. The download manager 1012 may transmit the file to a second user's terminal, or may store the file in the Internet storage space 120 associated with the second user based on a selection of the second user. The file stored in the Internet storage space 120 associated with the second user may be stored in a storage space corresponding to a path selected by the second user from among storage spaces assigned to the second user.

As another example, the file transmission manager 1010 may include the upload manager 1011 to receive, from a terminal of the first user, a file selected by the first user from among files stored in the terminal of the first user, or to receive, from an Internet storage space 120 associated with the first user, a file selected by the first user from among files stored in the Internet storage space 120 associated with the first user, and the download manager 1012 to store a file received from the terminal of the first user or the Internet storage space 120 associated with the first user, in a Internet storage space 120 associated with the second user. A file stored in the Internet storage space 120 associated with the second user may be stored in a storage space corresponding to a path selected by the second user from among storage spaces assigned to the second user.

A file received in response to a file transmission request of the first user may be stored in a temporary storage system 130 associated with the file transmission management system 1000. For example, when the second user approves a file transmission, the file transmission manager 1010 may receive a file stored in the temporary storage system 130 and then provide the received file to the second user.

The file transmission manager 1010 may also store conversations and/or messages transmitted between users in an Internet storage space 120 associated with the users or a mail server 160 associated with the file transmission management system 1000 and thus provide backup for saved conversations and/or messages between the users.

The file transmission management system 1000 may further include a session manager 1020 to manage a connection session through user terminals using the mobile messaging service. The session manager 1020 may transmit, to the user terminals, transmission state information and transmission result information associated with the file transmission. As described above with reference to FIG. 1, the session manager 1020 may be connected to the file transmission management system 1000 as a separate system, or may be modularized and be included in the file transmission management system 1000 as shown in FIG. 10.

According to exemplary embodiments of the present invention, when transmitting a file through a mobile messaging service, it may be possible to receive a file uploaded from a user terminal, or a file selected by the user from among a plurality of files stored in an Internet storage space 120 of the user, and to provide the file to another user. When transmitting a file through a mobile messaging service, it may also be possible to transmit a corresponding file to a user terminal to which the file is to be provided, or to store the corresponding file in an Internet storage space 120 associated with the user.

The exemplary embodiments according to the present invention can be implemented in numerous ways. For example, the exemplary embodiments may be implemented using hardware, software, or a combination thereof. When implemented in software, the software code can be executed on any suitable processor or collection of processors, whether provided in a single computer or distributed among multiple computers. It should be appreciated that any component or collection of components that perform the functions described above can be considered as one or more controllers that control the above-discussed function. The one or more controller can be implemented in numerous ways, such as with dedicated hardware, or with general purpose hardware (e.g., one or more processor) that is programmed using microcode or software to perform the functions recited above. For example, the file transmission manager described hereinabove may be a controller implemented in hardware. The file transmission manager may control the file transmission management system 100 to implement the various exemplary embodiments described hereinabove.

It should be appreciated that the various methods outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code.

It should be appreciated that exemplary embodiments of the invention are also directed to a computer readable medium encoded with one or more programs including instructions that, when executed on one or more computers or other processors, perform methods that implement the various exemplary embodiments of the invention discussed above. The computer-readable media may include, but are not limited to, transitory and non-transitory media, and volatile and non-volatile memory. The computer-readable media may include storage media, such as, for example, read-only memory (ROM), random access memory (RAM), floppy disk, hard disk, optical reading media (e.g., compact disc-read-only memory (CD-ROM), digital versatile discs (DVDs), hybrid magnetic optical disks, organic disks, flash memory drives or any other volatile or non-volatile memory, and other semiconductor media. In some cases, the computer-readable media may be electronic media, electromagnetic media, infrared, or other communication media such as carrier waves. Communication media generally embodies computer-readable instructions, data structures, program modules or other data in a modulated signal such as the carrier waves or other transportable mechanism including any information delivery media. Computer-readable media such as communication media may include wireless media such as radio frequency, infrared microwaves, and wired media such as a wired network. Also, the computer-readable storage media can store and execute computer-readable codes that are distributed in computers connected via a network. The computer-readable media also includes cooperating or interconnected computer-readable media that are in the processing system or are distributed among multiple processing systems that maybe local or remote to the processing system. The computer readable medium or media can be transportable, such that the program or programs stored thereon can be loaded onto one or more different computers or other processors to implement various aspects of the present invention as discussed above.

Various aspects of the invention may be implemented on one or more computer systems. Such computer systems may include input device(s), output device(s), processor(s), memory system(s), and storage unit(s), all or some of which are coupled, directly or indirectly, via an interconnection mechanism, which may be comprised of one or more buses, switches, and/or networks. The input device(s) may receive input from a user or terminal, and the output device(s) may display or transmit information to a user or a terminal. The processor(s) may execute a computer program (e.g., an operating system) which controls the execution of other computer programs, and provides scheduling, input/output and other device control, accounting, compilation, storage assignment, data management, memory management, communication, and data flow control.

The processor(s) may also execute one or more computer programs to implement various exemplary embodiments of the invention. These computer programs may be written in any type of computer programming language, including a procedural programming language, object-oriented programming language, macro language, or combination thereof. These computer programs may be stored in a storage system, which may hold information on a volatile or nonvolatile medium, and may be fixed or removable.

As an example, the file transmission management system 100, the client 110, the temporary storage system 130, the session control server 140, the DBGW 150, and the mail server 160 may be any combination of software and/or hardware, If implemented as hardware, each of the file transmission management system 100, the client 110, the temporary storage system 130, the session control server 140, the DBGW 150, and the mail server 160 may include input device(s), output device(s), processor(s), memory system(s), and storage unit(s). The file transmission management system 100 may be connected, via input/output devices, to the client 110, the temporary storage system 130, the session control server 140, the DBGW 150, and/or the mail server 160. The connections may be wired or wireless. A processor in the file transmission management system 100 may control execution of the various methods and embodiments of the invention described hereinabove.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A file transmission management system, comprising:
a controller to receive a file from an Internet storage unit associated with a first terminal in response to receiving a request for transmission of the file from the first terminal using a messaging service.

2. The system of claim 1, wherein the controller comprises:
an upload manager to receive the file from the Internet storage unit in response to the first terminal transmitting the request to a second terminal.

3. The system of claim 1, wherein the controller comprises:
a download manager to transmit the file to the second terminal or an Internet storage unit associated with a second terminal.

4. The system of claim 3, wherein the download manager transmits the file to the second terminal, or stores the file in the Internet storage unit associated with the second terminal based on a selection received via the second terminal.

5. The system of claim 4, wherein the file stored in the Internet storage unit associated with the second terminal is stored in an Internet storage unit corresponding to a path selected by the second terminal.

6. The system of claim 1, wherein:
the file is stored in a temporary storage system associated with the file transmission management system, and
in response to receiving an approval from the second terminal for transmission of the file, the controller receives the stored file from the temporary storage system and provides the file to the second terminal.

7. A file transmission management system, comprising:
a controller to receive a file and store the file in an Internet storage unit associated with a second terminal in response to receiving a request from a first terminal for transmission of the file through to messaging service.

8. The system of claim 7, wherein the controller comprises:
an upload manager to receive, from the first terminal, a selected file stored in the first terminal, or to receive, from an Internet storage unit associated with the first terminal, a selected file stored in the Internet storage unit associated with the first terminal.

9. The system of claim 8, wherein the controller further comprises:
a download manager to store the file received from the first terminal or the Internet storage unit associated with the first terminal, in the Internet storage unit associated with the second terminal.

10. The system of claim 7, wherein the file stored in the Internet storage unit associated with the second terminal is stored in an Internet storage unit corresponding to a path selected by the second terminal.

11. The system of claim 7, wherein:
the received file is stored in a temporary storage system associated with the file transmission management system, and
in response to the second terminal approving the transmission of the file, the controller receives the stored file from the temporary storage system and stores the received file in the Internet storage unit associated with the second terminal.

12. The system of claim 7, further comprising:
a session manager to manage a connection session between the first terminal and the second terminal using the messaging service,
wherein the session manager transmits transmission state information and transmission result information associated with the transmission of the file to the first terminal and the second terminal.

13. The system of claim 7, wherein the controller stores messages transmitted between the first terminal and the second terminal using the messaging service in the Internet storage unit associated with the second terminal, an Internet storage unit associated with the first terminal, or a mail server associated with the file transmission management system.

14. A file transmission management method, comprising:
receiving a file from an Internet storage unit associated with a first terminal in response to receiving a request for transmission of the file from the first terminal using a messaging service, the file being stored in the Internet storage unit associated with the first terminal.

15. The method of claim 14, wherein the receiving comprises receiving the file from the Internet storage unit in response to the first terminal transmitting the request to a second terminal.

16. The method of claim 14, further comprising:
providing the file to a second terminal in response to the request,
wherein the providing comprises transmitting the file to the second terminal or an Internet storage unit associated with the second terminal.

17. A file transmission management method, comprising:
storing a file in an Internet storage unit associated with a second terminal in response to a request from a first terminal for transmission of the file through a messaging service.

18. The method of claim 17, wherein the storing comprises receiving, from the first terminal, a selected file stored in the first terminal, or receiving, from the Internet storage unit associated with the second terminal, a selected file stored in the Internet storage unit associated with the first terminal.

19. The method of claim 18, wherein the storing further comprises storing the file received from the first terminal or the Internet storage unit associated with the first terminal, in an Internet storage unit associated with the second terminal.

20. A non-transitory computer-readable recording medium to store a computer readable program, that when executed, implements the method of claim 14.
